(19) United States
(12) Patent Application Publication
(10) Pub. No.: US 2026/0316574 A1
(43) Pub. Date: Oct. 15, 2026

(54) METHOD FOR INFLUENCING THE TEMPERATURE OF AT LEAST ONE TRANSMISSION OF AN ELECTRIC VEHICLE

(71) Applicant: MAGNA Powertrain GmbH & Co KG, Lannach (AT)

(72) Inventor: Erik Hechtl, Passail (AT)

(21) Appl. No.: 19/481,607

(22) PCT Filed: Apr. 16, 2024
(86) PCT No.: PCT/EP2024/060247

§ 371 Date: Nov. 5, 2025

(30) Foreign Application Priority Data
May 11, 2023 (DE) 10 2023 204 368.8

(51) Int. Cl. B60L 1/00

(52) U.S. Cl. CPC B60L 1/003; B60L 2240/32; B60L 2240/425; B60L 2240/485; B60L 2240/486; B60L 2240/642

(57) ABSTRACT

A method for influencing the temperature of at least one transmission of an electric vehicle uses an electric oil pump. The electric vehicle has at least one electric machine, at least one transmission connected downstream of the electric machine, and at least one oil circuit for cooling and/or lubricating the electric machine and the transmission. The oil circuit has at least one electric oil pump. The electric oil pump is activated if the temperature of the electric machine is greater than the temperature of the oil in the transmission and if the transmission rotational speed exceeds a threshold.

### CROSS-REFERENCE TO RELATED APPLICATIONS

This application is a National Stage of International Application No. PCT/EP2024/060247, filed Apr. 16, 2024, which claims priority to DE 10 2023 204 368.8, filed May 11, 2023. The entire disclosures of each of the above applications are incorporated herein by reference.

### FIELD

The present disclosure relates to a method for influencing the temperature of at least one transmission of an electric vehicle, wherein the electric vehicle has at least one electric machine and at least one transmission connected downstream of the electric machine and at least one oil circuit for cooling and/or lubricating the electric machine and the transmission, wherein the oil circuit comprises at least one electric oil pump.

### BACKGROUND

This section provides information related to the present disclosure which is not necessarily prior art.

In electric vehicles, electric machines are used to generate the drive torque. It is possible that the electric vehicles are designed as pure electric vehicles, which use only one or more electric motors for the drive, or that these are designed as hybrid vehicles, which use an internal combustion engine and a motor-operated electric machine in parallel as a drive motor.

In the electric machines, it is necessary to transport away the waste heat which is generated during the conversion of electrical energy into movement energy, in order to operate the drive in a predefined temperature range. Furthermore, it is necessary to lubricate a transmission which is connected downstream of the electric machine and likewise to carry away waste heat which arises as a result of friction and other loss processes in the transmission.

The prior art discloses an extremely wide range of devices for cooling and lubricating transmissions for vehicles. In the most familiar embodiment, the transmissions are designed with an oil sump, wherein the transmission oil located therein is used both as a lubricant and as a coolant for the transmission. To this end, an (electric) oil pump often provides a transmission oil stream in electric vehicles, which, in addition to the cooling and lubrication of the transmission, also serves to cool the electric machine.

As is known, the efficiency (the effectiveness) of a transmission rises with increasing transmission oil temperature. This applies in particular at high rotational speeds and low torques, for example during conventional driving of the vehicle on a freeway.

### SUMMARY

This section provides a general summary of the disclosure, and is not a comprehensive disclosure of its full scope or all of its features.

Starting from this point, it is an object of the present disclosure to indicate a method for influencing the temperature of at least one transmission of an electric vehicle by which, in specific driving situations of the electric vehicle, an increase in the efficiency of the transmission can be achieved.

The object is achieved by a method for influencing the temperature of at least one transmission of a vehicle as described herein. Advantageous embodiments of the present disclosure are described herein.

The method according to the present disclosure is used to influence the temperature of at least one transmission of an electric vehicle and is used in particular in an electric vehicle having at least one electric machine, at least one transmission connected downstream of the electric machine and at least one oil circuit for cooling and/or lubricating the electric machine and the transmission, wherein the oil circuit has at least one electric oil pump.

An oil circuit is substantially an oil line arrangement for the circulation of oil.

According to the present disclosure, the electric oil pump is activated when the temperature of the electric machine is higher than the temperature of the oil in the transmission and when the transmission rotational speed exceeds a limiting value.

In such a way, in a defined driving situation of the electric vehicle, the temperature of the oil and, via the oil, the temperature of the transmission can be increased via the waste heat of the electric machine, and thus the efficiency of the transmission can be raised.

Particularly preferably, the electric oil pump is deactivated when the temperature of the electric machine is less than or equal to the temperature of the oil in the transmission or when the transmission rotational speed falls below the limiting value.

The temperature of the electric machine is determined via the temperature of at least one magnet of the electric machine and/or via the temperature of at least one winding head of the electric machine.

The electric oil pump is preferably also activated when the temperature of the electric machine, namely the temperature of a magnet of the electric machine or the temperature of a winding head of the electric machine, reaches or exceeds a critical limiting value.

By way of the method according to the present disclosure it is possible to minimize transmission losses at high rotational speeds and low torques of the electric vehicle.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The present disclosure is described below by way of example with reference to the drawing.

The Figure shows, schematically, a block diagram of a method.

### DETAILED DESCRIPTION

A method sequence of a method according to the present disclosure is illustrated in the Figure by using a block diagram.

The method according to the present disclosure is used to influence the temperature of at least one transmission of an electric vehicle and is used in particular in an electric vehicle having at least one electric machine, at least one transmission connected downstream of the electric machine and at least one oil circuit for cooling and/or lubricating the electric machine and the transmission. The oil circuit has at least one electric oil pump.

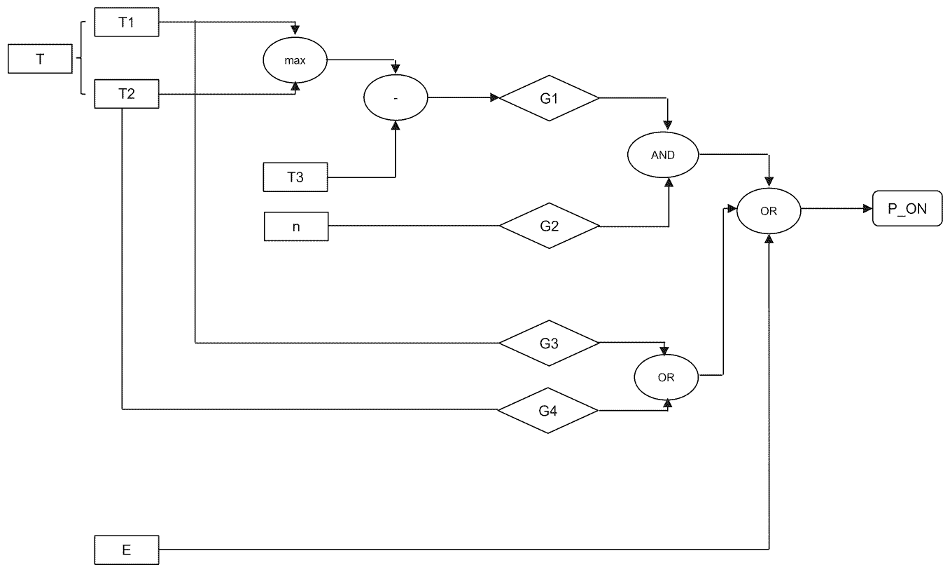

The electric oil pump is activated P_ON when the temperature of the electric machine T is higher than the temperature of the oil in the transmission T3 and when the transmission rotational speed n exceeds a limiting value G2. The threshold value for a temperature difference between the temperature of the electric machine T and the temperature of the oil in the transmission T3 is represented in the schematic block diagram illustrated in FIG. 1 via the term “G1”.

The electric oil pump is deactivated when the temperature of the electric machine T is less than or equal to the temperature of the oil in the transmission T3 or when the transmission rotational speed n falls below the limiting value G2.

The temperature of the electric machine T is determined via the temperature of at least one magnet of the electric machine T2 and/or via the temperature of at least one winding head of the electric machine T1.

Furthermore, the electric oil pump is activated P_ON when the temperature of the electric machine T, namely the temperature of a magnet of the electric machine T2 or the temperature of a winding head of the electric machine T1, reaches or exceeds a critical limiting value.

The electric oil pump is also activated P_ON as a result of a specific event E-for example in a lubrication mode, when reversing, when traveling uphill, etc.

### LIST OF REFERENCE SIGNS (PART OF THE DESCRIPTION)

T Temperature of an electric machine
T1 Temperature of a winding head of an electric machine
T2 Temperature of a magnet of an electric machine
T3 Temperature of oil in a transmission
G1 Threshold value for a temperature difference between the electric machine and the oil in the transmission
G2 Limiting value
G3 Critical limiting value of a winding head
G4 Critical limiting value of a magnet
n Rotational speed of an axle
E Specific event
P_ON Oil pump activated

What is claimed is:

1. A method for influencing the temperature of at least one transmission of an electric vehicle, wherein the electric vehicle has at least one electric machine, at least one transmission connected downstream of the electric machine and at least one oil circuit for cooling and/or lubricating the electric machine and the transmission, the method comprising:
activating at least one electric oil pump of the oil circuit when a temperature of the electric machine is higher than a temperature of oil in the transmission and when a transmission rotational speed exceeds a limiting value.

2. The method as claimed in claim 1,
wherein the method further comprises deactivating the electric oil pump when the temperature of the electric machine is less than or equal to the temperature of the oil in the transmission or when the transmission rotational speed falls below the limiting value.

3. The method as claimed in claim 1,
wherein the method further comprises determining the temperature of the electric machine via a temperature of at least one magnet of the electric machine and/or via a temperature of at least one winding head of the electric machine (T1).

4. The method as claimed in claim 1,
wherein the method further comprises activating the electric oil pump when the temperature of the electric machine reaches or exceeds a critical limiting value.

5. The method as claimed in claim 1,
wherein the method further comprises deactivating the electric oil pump when the transmission rotational speed falls below the limiting value.

6. The method as claimed in claim 1,
wherein the method further comprises deactivating the electric oil pump when the temperature of the electric machine is less than or equal to the temperature of the oil in the transmission.

7. The method as claimed in claim 2,
wherein the method further comprises determining the temperature of the electric machine via a temperature of at least one magnet of the electric machine and/or via a temperature of at least one winding head of the electric machine.

8. The method as claimed in claim 7,
wherein the method further comprises activating the electric oil pump when the temperature of the electric machine reaches or exceeds a critical limiting value.

9. The method as claimed in claim 8,
wherein the method further comprises activating characterized in that the electric oil pump when the temperature of the magnet of the electric machine (T2) or the temperature of the winding head of the electric machine (T1), reaches or exceeds a critical limiting value.

10. The method as claimed in claim 2,
wherein the method further comprises activating the electric oil pump when the temperature of the electric machine reaches or exceeds a critical limiting value.

11. The method as claimed in claim 1,
wherein the temperature of the transmission is increased via waste heat of the electric machine.

12. The method as claimed in claim 1, wherein the electric oil pump is activated in response to a specific vehicle event.

13. The method as claimed in claim 12, wherein the specific vehicle event is at least one of a lubrication mode, when reversing, or when traveling uphill.
